(19) United States
(12) Patent Application Publication
(10) Pub. No.: US 2009/0239514 A1
(43) Pub. Date: Sep. 24, 2009

(54) METHODS AND APPARATUSES FOR PROVIDING ADVERTISEMENTS TO A MOBILE DEVICE

(75) Inventors: Jason B. Kenagy, La Jolla, CA (US); Amy Suzanne McGaraghan, Berkeley, CA (US)

Correspondence Address: QUALCOMM INCORPORATED, 5775 MOREHOUSE DR., SAN DIEGO, CA, 92121, US

(73) Assignee: Qualcomm Incorporated, San Diego, CA (US)

(21) Appl. No.: 12/053,017

(22) Filed: Mar. 21, 2008

(51) Int. Cl. H04Q 7/22; H04N 7/025

(52) U.S. Cl. 455/414.3; 725/34

(57) ABSTRACT

Embodiments include a method of increasing advertisement viewing time by a user of a broadcast reception and rendering device, comprising: rendering a broadcast stream associated with a channel from the plurality of channels; providing an interface to the user for changing the rendered channel to a second channel from the plurality of channels; detecting that the user is engaging with the interface for changing the rendered channel; and in response to the detecting, displaying at least one advertisement, the advertisement selected by reference to the user profile and displayed during the channel change. Embodiments also include a method of providing advertisements to a mobile device comprising: receiving a signal indicative of user interest in the displayed advertisement; detecting a request from the user to change a channel on the mobile device; and in response to the detection, displaying data relating to the advertisement.

### RELATED APPLICATIONS

This application generally relates to communications, and more specifically, to communication of advertisements in a broadcast network so as to increase advertisement viewing time by a user.

### BACKGROUND

Electronic devices such as mobile telephone handsets and other mobile devices may be configured to receive broadcasts of sports, entertainment, advertisements, or other informational multimedia content items. For example, audio and or video data may be communicated using a broadband broadcast communications link to the electronic devices. There is a need for improving the delivery of advertisements to mobile device users so that the advertisements are delivered in more attractive and efficient ways.

### SUMMARY

In certain embodiments, a method of increasing advertisement viewing time by a user of a broadcast reception and rendering device comprises: storing a user profile in a storage module of a viewing device; receiving a plurality of broadcast channels by the viewing device; rendering a broadcast stream associated with a channel from the plurality of channels; providing an interface to the user for changing the rendered channel to a second channel from the plurality of channels; detecting that the user is engaging with the interface for changing the rendered channel; and in response to the detecting, displaying at least one advertisement, the advertisement selected by reference to the user profile and displayed during the channel change.

In certain embodiments, a method of providing advertisements by a mobile device comprises: receiving at least one advertisement directed to the mobile device; displaying the advertisement by the mobile device; receiving a signal indicative of user interest in the displayed advertisement; detecting a request from the user to change a channel on the mobile device; and in response to the detection, displaying data relating to the advertisement.

In certain embodiments, an apparatus for displaying advertisements by a mobile device comprises: a receiver configured to receive at least one advertisement directed to the mobile device; a display configured to display the advertisement on the mobile device; and a processor configured to: generate a signal indicative of user interest in a displayed advertisement; detect a request from the user to change a channel on the mobile device; and in response to the detection, display data relating to the advertisement on the display.

In certain embodiments, an apparatus for providing advertisements by a mobile device, comprising: means for receiving at least one advertisement directed to the mobile device; means for displaying the advertisement by the mobile device; means for receiving a signal indicative of user interest in the displayed advertisement; means for detecting a request from the user to change a channel on the mobile device; and means for, in response to the detection, displaying data relating to the advertisement.

Methods and apparatuses of the disclosure each have several embodiments. No single one of the embodiments is solely responsible for its desirable attributes. Without limiting the scope of this invention, for example, as expressed by the claims which follow, its more prominent features will now be discussed briefly. After considering this discussion, and particularly after reading the section entitled “Detailed Description” one will understand how the features of this invention provide advantages that include allowing a mobile device to display data relating to an advertisement in which the user is interested.

### BRIEF DESCRIPTION OF THE DRAWINGS

FIG. 1 is a block diagram illustrating an exemplary system for providing broadcast content items to mobile devices.

FIG. 2 is a block diagram illustrating an example of a mobile device such as illustrated in FIG. 1.

FIG. 3 is a flowchart illustrating an example of a method for increasing advertisement viewing time by a user of a broadcast reception and rendering device.

FIGS. 4A and 4B are schematic diagrams illustrating examples of a process for detecting user changing channels, detecting user interest in rendered advertisement(s) and rendering advertisements based on user interest in a virtual channel of the broadcast service.

FIG. 5 is a flowchart illustrating an example of a method for detecting user interest in an advertisement rendered in FIGS. 3, 4A or 4B.

FIG. 6 is a flowchart illustrating another example of a method for detecting user interest in ad advertisement rendered in FIGS. 3, 4A or 4B.

FIG. 7 is a flowchart illustrating an example of a method for rendering interesting advertisements in a virtual channel of the mobile device broadcast service during channel “surfing.”

FIG. 8 is a flowchart illustrating an example of a method for rendering interesting advertisements in a virtual channel of the mobile device broadcast service upon request by the user.

### DETAILED DESCRIPTION

The following detailed description is directed to certain embodiments of the disclosure. However, the invention can be embodied in a multitude of different ways, for example, as defined and covered by the claims. It should be apparent that the embodiments herein may be embodied in a wide variety of forms and that any specific structure, function, or both being disclosed herein is merely representative. Based on the teachings herein one skilled in the art should appreciate that an embodiment disclosed herein may be implemented independently of any other embodiments and that two or more of these embodiments may be combined in various ways. For example, an apparatus may be implemented or a method may be practiced using any number of the embodiments set forth herein. In addition, such an apparatus may be implemented or such a method may be practiced using other structure, functionality, or structure and functionality in addition to or other than one or more of the embodiments set forth herein.

In one embodiment, a device rendering a program on a channel from a plurality of program channels detects a request from the user to change a channel. In response to the detection, the device retrieves data relating to advertisements in which the user is interested and display the retrieved data. In one embodiment, the device displays data relating to the advertisement in which the user is interested immediately after the user changes a single channel or changes a plurality of channels. In one embodiment, the device displays data relating to the advertisement in which the user is interested in a virtual channel. In one embodiment, the device additionally sends the data relating to the advertisement in which the user is interested to an email address of the user.

In one embodiment, the user indicates to the device that the user is interested in an advertisement that has been rendered or is being rendered on the device. In other embodiments, the device generates a signal indicative of user interest in an advertisement. Generating data related to user interest in an advertisement may be performed before, during or after the user is changing channels, or alternatively during content or advertisement viewing.

In one embodiment, in response to the data indicative of user interest in an advertisement, the device stores data relating to the advertisement (e.g., a user profile) in a storage device. The data relating to the advertisement may include the advertisement itself and/or additional information regarding the advertised products and services.

Accordingly, the users of a mobile device can identify an advertisement that they are interested in while watching content items. Subsequently, the user has an opportunity to watch the advertisement of interest without interrupting content viewing since the advertisement is provided during channels “surfing” sessions when the user is more receptive to viewing new content.

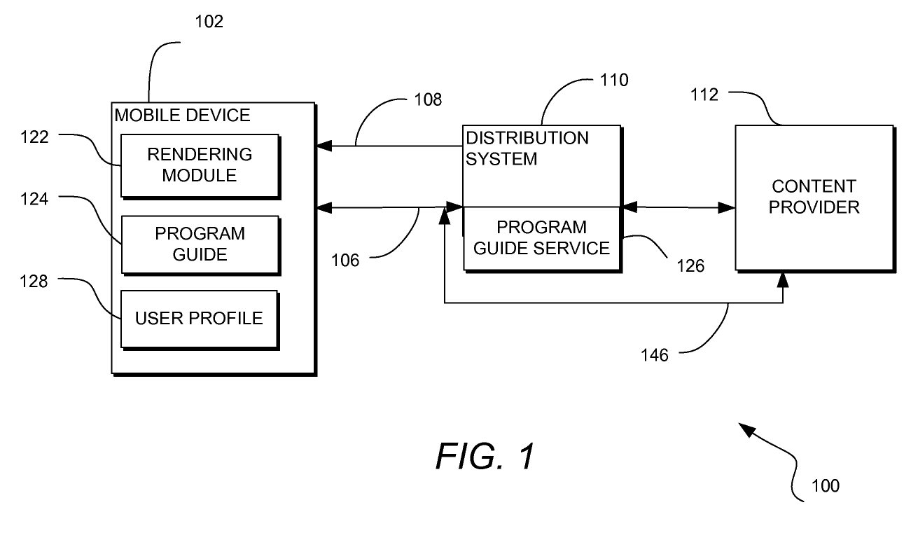

FIG. 1 is a block diagram illustrating an exemplary system 100 for providing broadcast content items to mobile devices 102 from one or more content providers 112 using a distribution system 110. While a single mobile device 102 is shown in FIG. 1, an exemplary system 100 may be configured to use any number of mobile devices 102. The system 100 also includes a distribution system 110 and a content provider 112. The distribution system 110 may receive data representing a multimedia content item from the content provider 112. The multimedia content items may be communicated over a wired or wireless content item communication link 108. The advertisements may also be communicated over a separate wired or wireless communication link that is different from the wired or wireless content item communication link 108. In one embodiment, the communications link 108 is a high speed or broadband link. In one embodiment, the content provider 112 communicates content directly over a second wireless or wired link 146 to the mobile device 102, bypassing the distribution system 110. It is to be recognized that in other embodiments multiple content providers 112 may provide content items using multiple distribution systems 110 to the mobile devices 102.

In the exemplary system 100 of FIG. 1, the content item communication link 108 is illustrated as a unidirectional network. However, the content item communication link 108 may also be a fully symmetric bi-directional network. The content item communication link 108 may comprise one or more wired and/or wireless links, including one or more of a Ethernet, telephone (e.g., POTS), cable, power-line, and fiber optic systems, and/or a wireless system comprising one or more of a code division multiple access (CDMA or CDMA2000) communication system, a frequency division multiple access (FDMA) system, a time division multiple access (TDMA) system such as GSM/GPRS (General Packet Radio Service)/EDGE (enhanced data GSM environment), a TETRA (Terrestrial Trunked Radio) mobile telephone system, a wideband code division multiple access (WCDMA) system, Mobile-Originated Short Message Service (MO-SMS) system, a 3G data network system, a high data rate (1xEV-DO or 1xEV-DO Gold Multicast) system, an IEEE 802.11 system, a MediaFLO system, a DMB system, an orthogonal frequency division multiple access (OFDM) system, or a DVB-H system.

In the exemplary system 100, the mobile device 102 may also be configured to communicate on a third communication link 106 which may comprise any of the networks described above with reference to the link 108. In one embodiment, the communication link 106 is a two way communication link such as is illustrated in the exemplary system 100. The communication link 106 may be used in communication between the mobile device 102 and the broadcast center or distribution system 110 and/or the content provider 112. In one embodiment, the distribution system 110 is a broadcast center. The third communication link 106 may be a wireless network configured to communicate voice traffic and/or data traffic. The communication link 106 may communicate program guide and other data between the distribution system 110 and the mobile device 102.

The mobile device 102 includes a rendering module 122 configured to render the multimedia content items received over the content item communication link 108. The rendering module 122 may include analog and/or digital technologies. The rendering module 122 may include one or more multimedia signal processing systems, such as video encoders/decoders, using encoding/decoding methods based on international standards such as MPEG-x and H.26x standards. Such encoding/decoding methods generally are directed towards compressing the multimedia data for transmission and/or storage.

In addition to communicating content items to the mobile device 102, the distribution system 110 may also include a program guide service 126. The program guide service 126 receives program schedule and content related data from the content provider 112 and/or other sources and communicates data representing an electronic programming guide (EPG) 124 to the mobile device 102. The EPG 124 may include data related to the broadcast schedule of multiple content items available to be received over the content item communication link 108. The EPG data may include titles of content items, start and end times, category classification of content items (e.g., sports, movies, comedy, etc.), quality ratings, adult content ratings, etc. The EPG 124 may also be communicated to the mobile device 102 over the content item communication link 108 and stored in the mobile device 102.

Mobile devices such as mobile handsets and music/video players are often used by a particular user. Therefore, the mobile device 102 also includes a user profile 128. For example, the user profile 128 may be configured to store information indicative of content items selected for viewing by a user. In one embodiment, the user profile 128 stores data indicative of one or more content items that will be, or have been, viewed, recorded, or otherwise accessed by the user. The profile may be updated based on data indicative of accessed content items, a category associated with the accessed content items, an elapsed viewing time of the accessed content items, and a channel associated with the content items.

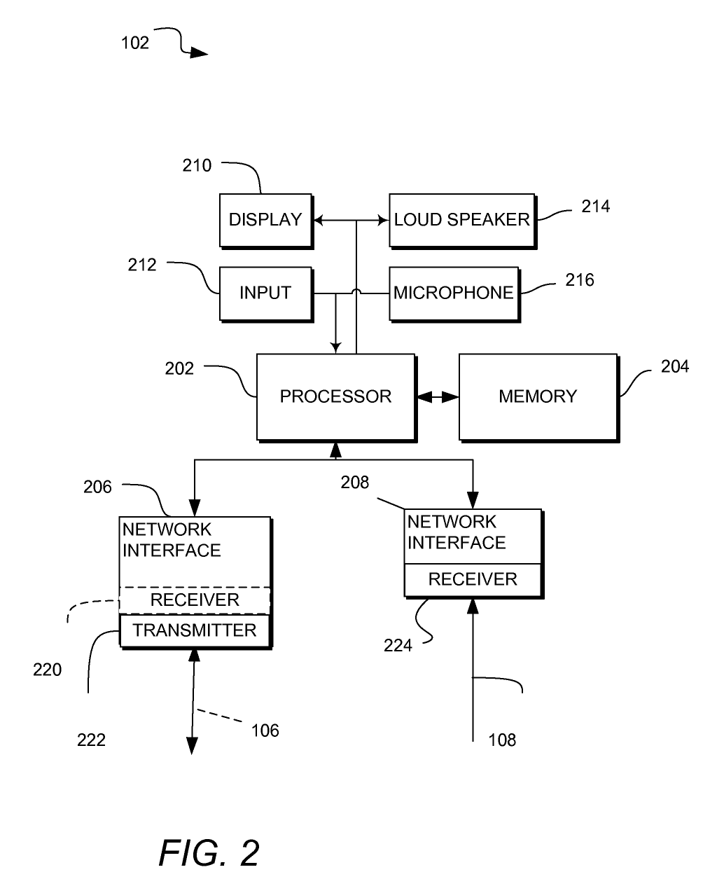

FIG. 2 is a block diagram illustrating an example of the mobile device 102 such as illustrated in FIG. 1. The mobile device 102 includes a processor 202 that may be in communication with a memory (or storage device) 204 and a network interface 208 that communicates over the content item communication link 108. The network interface 208 includes a receiver 224 configured to receive the unidirectional content item communication link 108. The network interface 208 and the receiver 224 may receive signals according to wired technologies which are the same as or similar to those for the content item communication link 108.

The mobile device 102 may include an optional second network interface 206 for communicating using the bi-directional communication link 106. The network interface 206 may include any suitable antenna (not shown), a receiver 220, and a transmitter 222 so that the mobile device 102 can communicate with one or more devices over the bi-directional communication link 106.

The mobile device 102 may also includes one or more of a display 210, a user input device 212 such as a key, touch screen, or other suitable tactile input device, a loudspeaker 214 comprising a transducer adapted to provide audible output based on a signal received over the communication link 106 and/or a microphone 216 comprising a transducer adapted to provide audible input of a signal that may be transmitted over the communication links 106 or 108.

The mobile device 102 may comprise at least one of a mobile handset, a personal digital assistant, a laptop computer, a headset, a vehicle hands free device, or any other electronic device. For example, one or more embodiments taught herein may be incorporated into a phone (e.g., a cellular phone), a personal data assistant (“PDA”), an entertainment device (e.g., a music or video device), a headset (e.g., headphones, an earpiece, etc.), a microphone, or any other suitable device.

The components described herein may be implemented in a variety of ways. Referring to FIG. 2, the mobile device 102 may be represented as a series of interrelated functional blocks that may represent functions implemented by, for example the processor 202, software (not shown), some combination thereof, or in some other manner as taught herein. For example, the processor 202 may facilitate user input using the input devices 212. Further, the transmitter 222 may comprise a processor (not shown in FIG. 2) that provides various functionalities relating to transmitting information, for example, to another mobile device 102, or to an email address of a user. Also, the receivers 220 or 224 may comprise a processor (not shown in FIG. 2) to provide various functions relating to receiving information, in example, from another mobile device 102.

In some embodiments, the device or apparatus 102 comprises an integrated circuit (“IC”). Thus, the integrated circuit may comprise one or more processors that provide the functionality of the processor components illustrated in FIG. 2. For example, in some embodiments a single processor implements the functionality of the illustrated processor components, while in other embodiments more than one processor implements the functionality of the illustrated processor components. In addition, in some embodiments the integrated circuit comprises other types of components that implement some or all of the functionality of the illustrated processor components.

Any illustrative logical blocks, modules, and circuits described in connection with the embodiments disclosed herein may be implemented within or performed by an integrated circuit, an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Those skilled in the art will recognize that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium may be coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

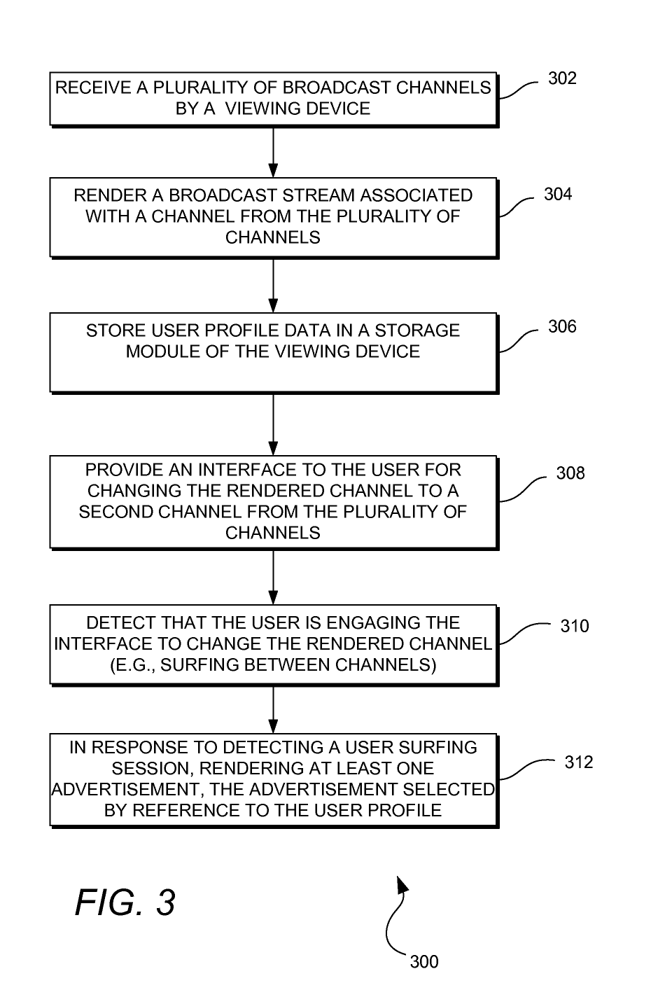

FIG. 3 is a flowchart illustrating an example of a method 300 for increasing advertisement viewing time by a user of a broadcast reception and rendering device, such as mobile device 102. Advertisements may be selected by reference to the user profile and rendered while the user is changing channels. At block 302, the mobile device 102 receives a plurality of broadcast channels of content items. The content items may be received over a broadcast network such as the content item communication link 108.

Next, at block 304, the mobile device 102 renders a broadcast stream associated with a channel from the plurality of channels. An advertisement may be rendered at the same time as rendering the content items received by the mobile device 102. The advertisement may also be rendered while the content item rendering is “paused,” e.g., via user request. The advertisements and the content items may be rendered in different areas (e.g., windows) of the screen of the display 210 or in the same area but in temporal succession.

Continuing from block 304, at block 306 user profile data are stored in the user profile 128 which may be stored on a storage module of the mobile device 102. In one embodiment, the user profile includes demographic information, such as the user's age range, living area, particular interest, etc. Correspondingly, metadata may be incorporated in the broadcast stream of advertisements so that particular users may view particular advertisements based on the demographic information stored in their user profile 128.

The user profile 128 may also include the user's preferences to particular advertisements. In one embodiment, the user notifies the mobile device 102 of his or her interest in an advertisement being rendered during block 304 by selecting a trigger in the advertisement. In another embodiment, the user presses a certain key or key sequence on the device to notify the mobile device 102 of his or her interest in the advertisement being rendered. Upon receiving the user's indication of his or her interest in an advertisement, the mobile device 102 updates the user profile 128 correspondingly.

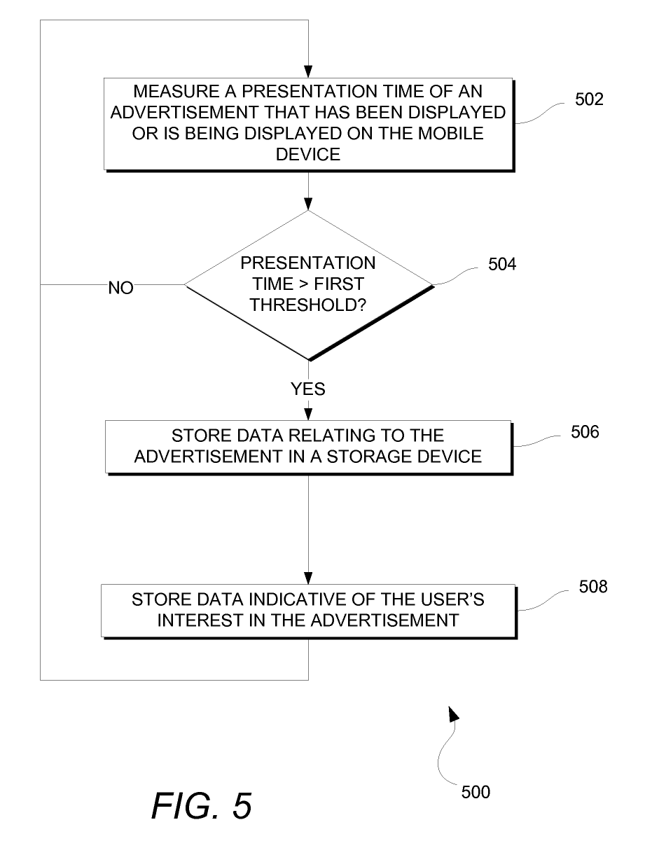

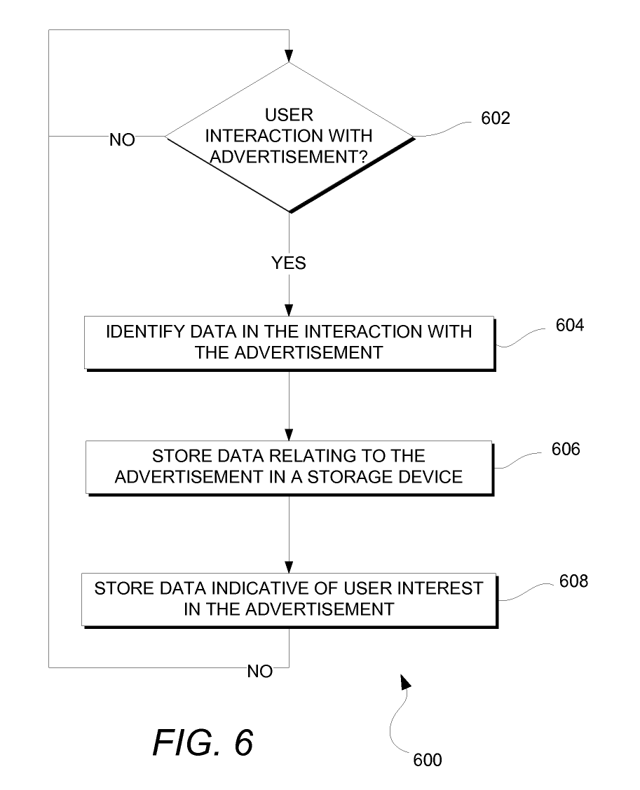

In another embodiment, the mobile device 102 receives a signal indicative of user interest in an advertisement that has been rendered or is being rendered during block 304. This signal may be generated by the user via the input device 212. For example, the user selects a soft key on the device to indicate that he or she is interested in the advertisement that has been rendered or is being rendered on the mobile device 102. In a further example, the user selects a designated area of the touch screen of the display 210 to indicate his or her interest in the rendered advertisement. The signal received in block 406 may also be generated by the mobile device 102. Two embodiments of generating a signal indicative of user interest in an advertisement are described in later portions of this specification with respect to FIGS. 5 and 6.

Method 300 further includes block 308 where the mobile device 102 provides an interface to the user so that the user may change the rendered channel to a second channel from the plurality of channels. In one embodiment, the user presses a channel up or channel down key on the device to generate a linear channel change request. In another embodiment, the user selects a soft channel up or channel down key on the touch screen of the display 210.

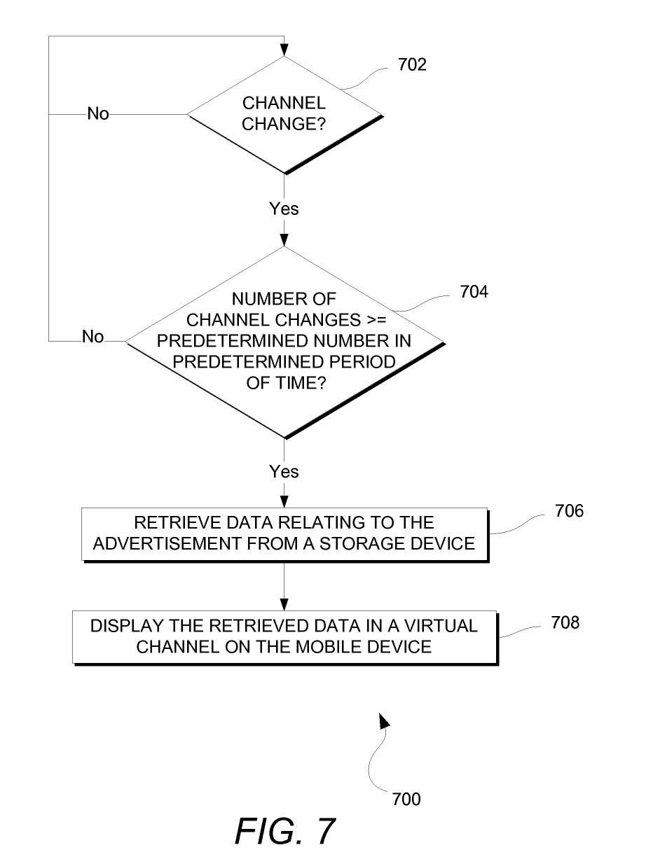

Next, at block 310, the mobile device 102 detects that the user is engaging the interface to change the rendered channel as part of “surfing” between channels. An exemplary process for performing this detection is described below with respect to FIG. 7, but, as may be appreciated, this detection may be implemented in other ways, which will be apparent to those skilled in the art from this discussion. In one embodiment, the mobile device 102 determines whether the user has generated a predetermined number of channel change requests in a predetermined period of time. For example, the mobile device 102 may determine that the user is engaging the interface as part of “surfing” between channels if the user presses the channel up or channel down key at least three times in a period of time of ten seconds. Additionally, the channel change request may be linear or nonlinear. For example, the user may change channels from Channel 5 to Channel 6 and then to Channel 8 and so on. The user may also change channels from Channel 5 to Channel 1 and then to Channel 7 and to Channel 8 and so on. Regardless of the particular sequence, the device is particularly configured to detect that the user is in “surfing” mode. In another embodiment, the device modifies the criteria for detecting “surfing” sessions by reference to the user profile and other historical data.

After performing the “surfing” detection, method 300 proceeds to block 312. In block 312, the mobile device 102, in response to detecting a “surfing” session, renders at least one advertisement. The advertisement is selected by reference to the user profile 128 and is rendered during the channel change session. As described earlier, the mobile device 102 may select advertisements based on the demographic information stored in the user profile 128 and the metadata incorporated in the broadcast stream. The mobile device 102 may also select advertisements based on the user's preference to particular advertisements. The user's preference is preferably stored in the user profile 128.

Advertisements or data relating to the advertisements may be rendered immediately before rendering the next content item in the arrived-at channel. In this case, data relating to the advertisement is rendered in an area (e.g., window) of the screen of the display 210 in which the next content item is rendered. The data relating to the advertisement may include the advertisement itself, any portion of the advertisement, or additional information regarding the advertised products and services. In one embodiment, the additional information regarding the advertised products and services includes the telephone numbers, web addresses, mailing addresses, etc. of the advertised company. In so doing, the system provides a new channel that renders the advertisement in which the user is interested. The data relating to the advertisement may also be rendered at the same time as the next content item, but at different areas (e.g., different windows) of the screen of the display 210. The data relating to the advertisement may be rendered in the virtual channel specifically for rendering advertisements in which the user is interested.

In other embodiments, the advertisement includes an on-line survey, an on-line contest, on-line voting, or similar on-line events, and do not advertise any products and services. In this case, the additional data relating to the advertisement include results of the events or any important stages where the on-line events require or allow user participation.

Method 300 may also store a history of rendered advertisements in response to channel change detection of block 3 10. Method 300 may also synchronize the rendering of a broadcast stream, for example, of the destination channel, with an end of the advertisement rendered by block 312.

Method 300 has been described above, but it should be noted that the number of the blocks, the sequence of the blocks and the process in each block are only intended to illustrate one embodiment. Various changes may be made to the illustrated method. For example, block 308 may be moved to right before block 306. Thus, the interface for changing to a second channel is provided to the user before the user profile data are stored in the storage module of mobile device 102. Another example is that blocks 304 and 306 are combined into a single block. Thus, the user profile data are stored in the storage module of the mobile device 102 at substantially the same time as the broadcast stream is being rendered. It is noted that such rearrangement of blocks could also be performed with respect to certain blocks of FIGS. 5, 6, 7 and 8.

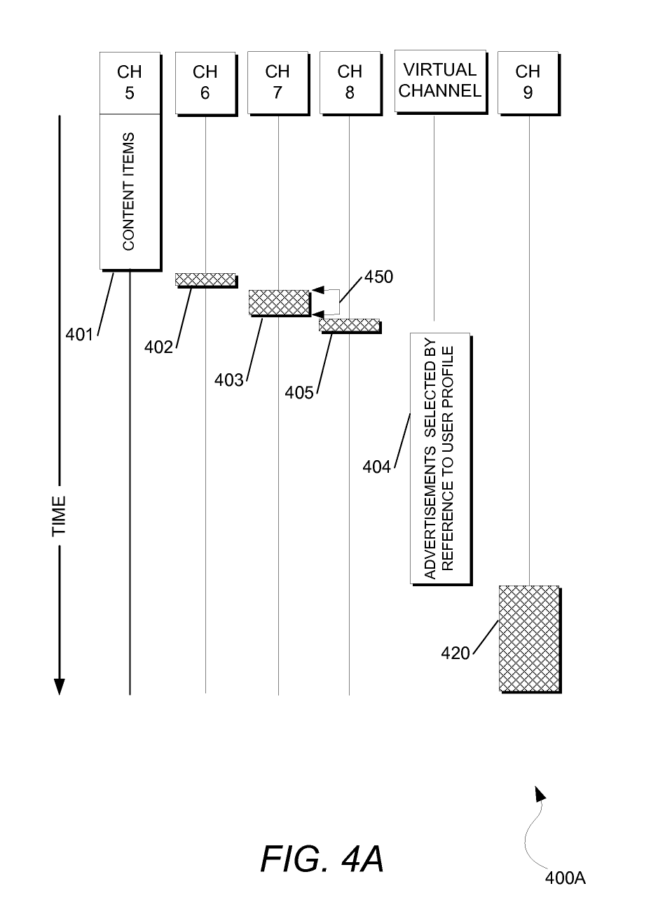

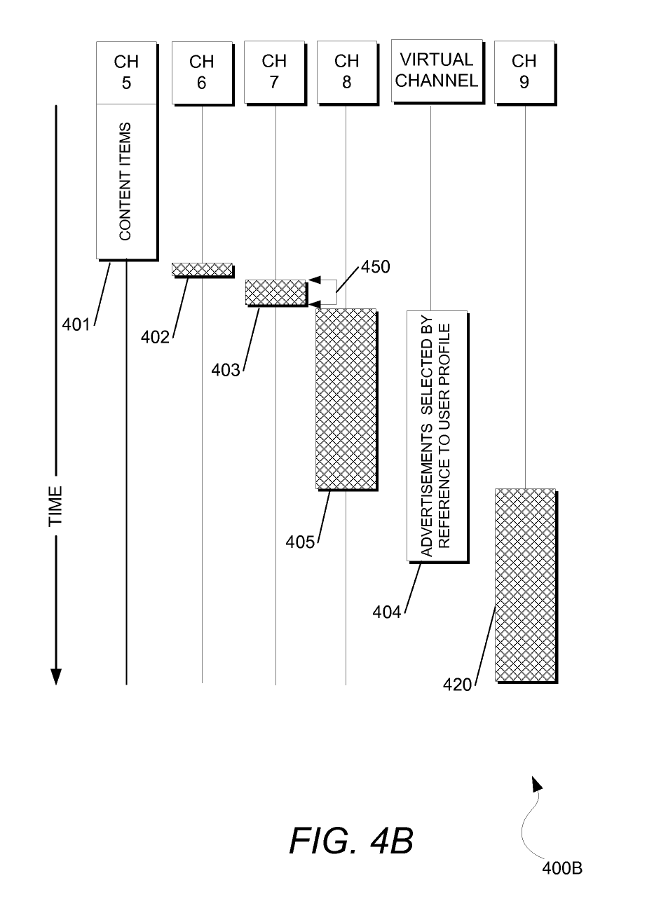

The process in blocks 310 and 312 of FIG. 3 can be illustrated in FIGS. 4A and 4B. FIGS. 4A and 4B are schematic diagrams illustrating examples of a process for detecting user channel changing sessions, detecting user interest in rendered advertisements, and rendering advertisements based on user interest in a virtual channel of the broadcast service. FIGS. 4A and 4B illustrate blocks 401-420, which are each representative of a time period during which content items are rendered on the display 210. As illustrated in FIG. 4A, the user initially views content items received on Channel 5 for a first period of time indicated by block 401. Then, the user switches to Channel 6, for example, by selecting a channel up key on the mobile device 102, to view the content items received on Channel 6 for a second period indicated by block 402. The second period (block 402) may be less than five seconds. Next, the user may decide they are not interested in the content items delivered on Channel 6. Thus, the user switches to Channel 7, for example, by selecting the channel up key again. In this embodiment, an advertisement is being rendered on Channel 7, and the user views this particular advertisement for a third period of time indicated by block 403. During the third period, the user may feel he or she is interested in this particular advertisement and therefore selects a certain key or key sequence to notify the mobile device 102 of their interest in this particular advertisement. As described above with respect to blocks 304 and 306 of FIG. 3, the user profile 128 may be updated accordingly to indicate that the user is interested in this particular advertisement.

Alternatively, the mobile device 102 may also monitor the viewing length of an advertisement and comparing the viewing length with a predetermined threshold length. As illustrated in FIG. 4A, the viewing length of the advertisement in Channel 7 is greater than or equal to the predetermined threshold length 450. Therefore, the mobile device 102 determines that the user is interested in this particular advertisement and thus updates the user profile 128 to indicate the user's preference to this particular advertisement.

FIG. 4A also illustrates that a user, after having viewed Channel 7 for the third period of time, switched to Channel 8 and then viewed the content items on Channel 8 for a fourth period of time, as indicated by block 405. At this particular point in the illustrated embodiment, the mobile device 102 detects a user “surfing” session and therefore renders an advertisement, as indicated by block 404, in a virtual channel. The rendered advertisement may be selected by reference to the user preference data stored in the user profile 128 or by reference to the demographic information stored in the user profile 128. The user preferred advertisements may be rendered in the same window as content items or in a separate window. In some implementations, the rendered advertisement is retrieved from a storage device of the mobile device 102.

After the fourth period (block 405), in addition to rendering the user preferred advertisement, the mobile device 102 may stop rendering content items on Channel 8 and may also receive input from the user to switch to other channels. The mobile device 102 may also continue rendering the content items on Channel 8 while rendering the advertisement in another window, as illustrated in FIG. 4B. In FIG. 4B, the content items of Channel 8 are rendered, as indicated by block 405, at the same as the whole, part, or a portion of the user preferred advertisements that are rendered, as indicated by block 404, in the virtual channel.

In FIG. 4A the mobile device 102 stops rendering the content items on Channel 8 when the user chooses to switch to Channel 9. After rendering the user preferred advertisement in the virtual channel, content items corresponding to Channel 9 are preferably rendered, as indicated in block 420. The user may also wait until rendering the user preferred advertisements is completed before selecting to switch to Channel 9. Therefore, the mobile device 102 may include a mechanism which synchronizes rendering the content items in the destination channel, e.g., Channel 9 in FIG. 4A, with the ending of rendering of the user preferred advertisement, either by user action or reaching an end of segment, in the virtual channel.

FIG. 4B illustrates another example for providing advertisement to a user in response to detecting a user “surfing” session. While FIG. 4A shows that the mobile device 102 detects a user “surfing” session in response to at least three requests of channel change (e.g., Channel 6→Channel 7, Channel 7→Channel 8, Channel 8→Channel 9) during a predetermined time, FIG. 4B shows that the mobile device 102 detects a user “surfing” session in response to at least two requests of channel change (e.g., Channel 6→Channel 7, Channel 7→Channel 8) during a predetermined time.

As illustrated in FIG. 4B, at the end of the third period (block 403), the mobile device 102 detects a user “surfing” session. The mobile device 102 responds by rendering, as indicated by block 404, the user preferred advertisement in a virtual channel. At substantially the same time, the mobile device 102 renders, as indicated by block 405, the content items of a channel, Channel 8 for example, in a separate window on the display 2 10.

At the end of the fourth period (block 405), the user selects to switch to Channel 9, and the mobile device 102 renders, as indicated by block 420, content items of Channel 9. As may be appreciated, the mobile device 102 may further include a mechanism or method to synchronize rendering content items from a destination channel, e.g., Channel 9 in FIG. 4B, with the completion of rendering the user preferred advertisement in the virtual channel.

As described above with respect to blocks 304 and 306 of FIG. 3, the signal indicative of user interest in an advertisement can be generated by the device in response to input by the user via the input device 212 or in response to detection by the mobile device 102. FIG. 5 illustrates a method 500 by which the mobile device 102 generates a signal indicative of user interest in an advertisement.

As shown in FIG. 5, method 500 begins at block 502 where the mobile device 102 measures the presentation time of an advertisement that has been rendered or is being rendered on the mobile device 102. In one embodiment, the processor 202 of the mobile device 102 is programmed to record start and stop times for each rendered advertisement in block 302 of FIG. 3 and calculate a presentation time for each advertisement.

Next in block 504, the mobile device 102 compares the presentation time of an advertisement with a first threshold. The first threshold may have a default value of, for example, five seconds. If the result of the comparison in block 504 is “No,” method 500 returns to block 502 and waits to measure the presentation time of another advertisement. Alternatively, method 500 may also be stopped or paused until it is revoked to measure the presentation time of another advertisement starting from block 502.

If the result of the comparison in block 504 is “Yes,” method 500 proceeds to block 506. In block 506, the mobile device 102 stores data relating to the advertisement in a storage device. The storage device may be any volatile or non-volatile storage devices internal or external to the mobile device 102. For example, the storage device may include the memory 204 as illustrated in FIG. 2. The data relating to the advertisement has been provided in this description above with respect to block 312 of FIG. 3. For example, the data relating to the advertisement may include the advertisement itself, any portion of the advertisement, or additional information regarding the advertised products and services.

After storing advertisement data, method 500 proceeds to block 508. In block 508, the mobile device 102 stores data indicative of the user's interest in the advertisement. Such storage may be implemented by updating the user profile 128. The mobile device 102 may also generate a signal indicative of user interest in the advertisement. The signal may be a flag or an indicator that is stored in a memory module of the mobile device 102 or in any other volatile or non-volatile storage devices internal or external to the mobile device 102. Update of the user profile may trigger off message, event, or other communication to another routine on the mobile device 102 or elsewhere.

Next, method 500 returns to block 502 and waits to measure the presentation time of another advertisement. Alternatively, method 500 may pause until it is revoked to measure the presentation time of another advertisement starting from block 502.

FIG. 6 illustrates the flowchart of another embodiment by which the mobile device 102 generates a signal indicative of user interest in an advertisement. Method 600 begins at block 602 where the mobile device 102 decides whether the user interacted with a rendered advertisement. In one embodiment, the advertisement is an interactive advertisement. While watching the interactive advertisement, the user may participate, for example, through the use of the input 212, the display 210, or the microphone 216 of the mobile device 102, and retrieve additional information regarding the advertised subject. In one embodiment, the additional information regarding the advertised subject includes the telephone numbers, web addresses, mailing addresses, etc. of the retail company.

In other embodiments, the advertisement is for an on-line survey, an on-line contest, on-line voting, or similar on-line events. In this case, the additional data relating to the advertisement is any results of the events or any important time when the on-line events require user participation.

If the result of the comparison in block 602 is “No,” method 600 returns to block 602 and waits until the user interacts with an advertisement. Alternatively, method 600 may also be stopped or paused until it is revoked to recognize the user's interaction with an advertisement starting from block 602.

If the result of the comparison in block 602 is “Yes,” method 600 proceeds to block 604. In block 604, the mobile device 102 generates data relating to the advertisement by reference to the user's interaction with the advertisement. As described above, the data relating to the advertisement may include the telephone number, web addresses, mailing addresses, etc. of the advertised company if the advertisement is an interactive advertisement.

Then, in block 606, the mobile device 102 stores data relating to the advertisement in a storage device. Here, the storage device may be any volatile or non-volatile storage devices internal or external to the mobile device 102. For example, the storage device may include the memory 204 as illustrated in FIG. 2. Various examples of the data relating to the advertisement have been given in the description above with respect to block 312 of FIG. 3. For example, the data relating to the advertisement may include the advertisement itself, any portion of the advertisement, or additional information regarding the advertised products and services.

Next, method 600 proceeds to block 608. In block 608, the mobile device 102 stores data indicative of the user's interest in the advertisement. This may be implemented by updating the user profile 128. The mobile device 102 may also generate a signal indicative of user interest in the advertisement. The signal may be a flag or an indicator that is stored in a memory module of the mobile device 102 or in any other volatile or non-volatile storage devices internal or external to the mobile device 102. Update of the user profile may trigger the transmission of a message, event, or other communication to another routine on the mobile device 102 or elsewhere.

Then, method 600 returns to block 602 and waits to detect user interaction with another advertisement. Alternatively, method 600 may pause until it is revoked to detect user interaction with another advertisement starting from block 602.

FIG. 7 is a flowchart illustrating method 700 for rendering advertisements in a virtual channel of the mobile device broadcast service during channel “surfing.” Method 700 begins at block 702 where the mobile device 102 determines whether a channel change request has been generated by the user. If the decision in block 702 is “No,” method 700 returns to block 702 to wait for a channel change request. If the decision in block 702 is “Yes,” method 700 proceeds to block 704. In block 704, the mobile device 102 decides whether the number of channel changes is greater than or equal to a predetermined number over a predetermined time. For instance, the predetermined number may be three and the predetermined time may be twenty seconds.

If the decision in block 704 is “No,” method 700 returns to block 702 to wait for another channel change request. If the decision in block 704 is “Yes,” method 700 proceeds to block 706. If so, the mobile device may have detected that the user is surfing between channels.

In block 706, the mobile device 102 retrieves data relating to the advertisement from a storage device of the mobile device 102, and then in block 708, renders the retrieved data in a virtual channel on the mobile device 102. For various embodiments of methods for retrieving and displaying the data relating to the advertisements, reference may be made to the description of block 312 of FIG. 3.

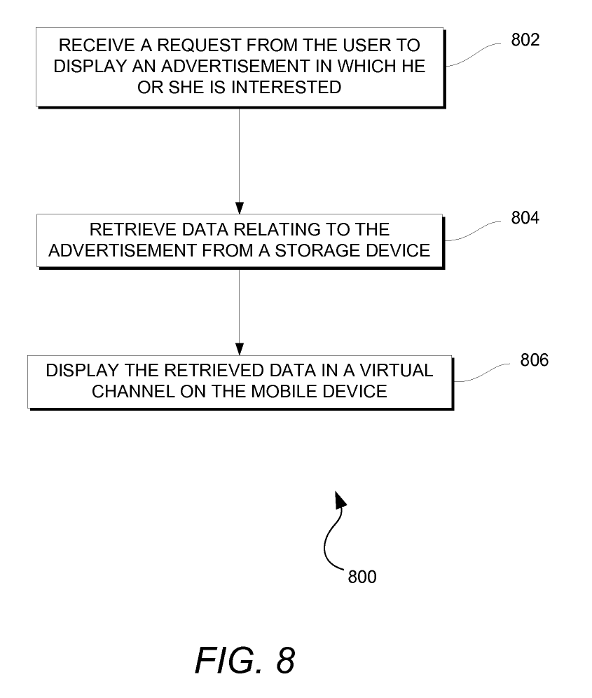

FIG. 8 is a flowchart illustrating an example of a method 800 for rendering advertisements in a virtual channel of the mobile device or in response to a user indication of interest. The mobile device 102 may have received the user interest signal, for example, in blocks 304 or 306 of FIG. 3 and therefore the user profile 128 has been updated with the request for additional information. As described above, the users may have selected a trigger in an advertisement to indicate their interest. As illustrated in FIG. 8, method 800 begins at block 802 where the mobile device 102 receives this request from the users to render additional information regarding an advertisement in which they are interested. This request may be made by the user via the input device 212. Sometime thereafter, the user presses a channel up or channel down key on the device one or more times so as to change the channel to a special channel number. This special channel number may represent a virtual channel in which the information for advertisements in which the user is interested is rendered. In another embodiment, the user presses a particular key on the remote control or the keypad of the mobile device 102, which directly changes the channel to the virtual channel. In a further embodiment, the user selects a soft channel up or channel down key or a particular soft key on the touch screen of the display 210.

Next, in block 804, the mobile device 102 retrieves data relating to the advertisements from a storage device. For example, the storage device may include the memory 204 as illustrated in FIG. 2. Various examples of the data relating to the advertisement have been given in the description above with respect to block 312 of FIG. 3. For example, the data relating to the advertisement may include the advertisement itself, any portion of the advertisement, or additional information regarding the advertised products and services. In one embodiment, the data relating to the advertisements have been saved to the storage device previously in block 506 of FIG. 5 or in block 606 of FIG. 6.

In other embodiments, the mobile device 102 requests advertisements from the content provider 112 by transmitting advertisement identification numbers. The device then receives the requested advertisements via the content item communication link 108. Next, in block 806, the mobile device 102 displays the retrieved data, for example, in a virtual channel.

The apparatuses and methods described herein may be used to improve targeted advertising systems by providing the content provider 112 with feedback data relating to the user or the mobile device as well as advertisements in which the user expressed an interest. The feedback data from the mobile device 102 allow the content provider 112 to deliver other advertisements in which the user is likely to be interested. Accordingly, instead of clogging network by delivering all advertisements over the broadcast network 108, the system 100 may be configured to allow for the filtering of delivered advertisements to take place at the content provider 112 location.

While the above detailed description has shown, described, and pointed out novel features of the invention as applied to various embodiments, it will be understood that various omissions, substitutions, and changes in the form and details of the device or process illustrated may be made by those skilled in the art without departing from the scope of this disclosure. As will be recognized, the invention may be embodied within a form that does not provide all of the features and benefits set forth herein, as some features may be used or practiced separately from others. The scope of this disclosure is defined by the appended claims, the foregoing description, or both. All changes which come within the meaning and range of equivalency of the claims are to be embraced within their scope.

1. A method of increasing advertisement viewing time by a user of a broadcast reception and rendering device, comprising:
storing a user profile in a storage module of a viewing device;
receiving a plurality of broadcast channels by the viewing device;
rendering a broadcast stream associated with a channel from the plurality of channels;
providing an interface to the user for changing the rendered channel to a second channel from the plurality of channels;
detecting that the user is engaging with the interface for changing the rendered channel; and
in response to the detecting, displaying at least one advertisement, the advertisement selected by reference to the user profile and displayed during the channel change.

2. The method of claim 1, wherein the user profile includes demographic information, and the method further comprises selecting an advertisement based upon the demographic information and metadata of the advertisement.

3. The method of claim 1, wherein detecting the user engaging with interface comprises determining whether the user has requested a predetermined number of channel changes in a predetermined period of time.

4. The method of claim 3, wherein the predetermined number is at least two.

5. The method of claim 4, wherein the predetermined number is at least three.

6. The method of claim 1, additionally comprising updating the user profile based upon selecting, by a user, a trigger in the displayed advertisement.

7. The method of claim 1, wherein detecting the user engaging with interface comprises detecting at least one linear channel change request.

8. The method of claim 1, wherein detecting the user engaging with interface comprises detecting at least two linear channel change requests.

9. The method of claim 1, further comprising storing a history of displayed advertisements in response to channel change detection.

10. The method of claim 1, further comprising synchronizing rendering of a broadcast stream with an end of the advertisement.

11. A method of providing advertisements by a mobile device, comprising:
receiving at least one advertisement directed to the mobile device;
displaying the advertisement by the mobile device;
receiving a signal indicative of user interest in the displayed advertisement;
detecting a request from the user to change a channel on the mobile device; and
in response to the detection, displaying data relating to the advertisement.

12. The method of claim 11, wherein the data is displayed in a virtual channel of the mobile device broadcast service.

13. The method of claim 11, wherein the data includes the displayed advertisement selected by the user interest signal.

14. The method of claim 11, additionally comprising retrieving the data from a storage device of the mobile device.

15. The method of claim 14, wherein the advertisement includes an interactive element and the data is identified by the user's interaction with the interactive element.

16. The method of claim 11, further comprising sending at least a portion of the data to an email address.

17. The method of claim 11, wherein the signal is generated by measuring a presentation time of the advertisement.

18. The method of claim 11, further comprising synchronizing displaying of content items with an end of the data relating to the advertisement.

19. An apparatus for displaying advertisements by a mobile device, comprising:
a receiver configured to receive at least one advertisement directed to the mobile device;
a display configured to display the advertisement on the mobile device; and
a processor configured to:
generate a signal indicative of user interest in a displayed advertisement;
detect a request from the user to change a channel on the mobile device; and
in response to the detection, display data relating to the advertisement on the display.

20. The apparatus of claim 19, wherein the display displays the data in a virtual channel of the mobile device broadcast service.

21. The apparatus of claim 19, wherein the data includes the displayed advertisement selected by the user interest signal.

22. The apparatus of claim 19, wherein the processor is additionally configured to retrieve the data from a storage device of the mobile device.

23. The apparatus of claim 22, wherein the advertisement includes an interactive element and the data is identified in the user's interaction with the interactive element.

24. The apparatus of claim 19, further comprising a transmitter configured to send at least a portion of the data to an email address.

25. The apparatus of claim 19, wherein the processor is further configured to generate the signal by measuring a presentation time of the advertisement.

26. The apparatus of claim 19, wherein the processor is further configured to synchronize displaying of content items with an end of the data relating to the advertisement.

27. An apparatus for providing advertisements by a mobile device, comprising:
means for receiving at least one advertisement directed to the mobile device;
means for displaying the advertisement by the mobile device;
means for receiving a signal indicative of user interest in the displayed advertisement;
means for detecting a request from the user to change a channel on the mobile device; and
means for, in response to the detection, displaying data relating to the advertisement.

28. The apparatus of claim 27, wherein the data is displayed in a virtual channel of the mobile device broadcast service.

29. The apparatus of claim 27, wherein the data includes the displayed advertisement selected by the user interest signal.

30. The apparatus of claim 27, further comprising means for retrieving the data from a storage device of the mobile device.

31. The apparatus of claim 30, wherein the advertisement includes an interactive element and the data is identified by the user's interaction with the interactive element.

32. The apparatus of claim 27, further comprising means for sending at least a portion of the data to an email address.

33. The apparatus of claim 27, wherein the signal is generated by measuring a presentation time of the advertisement.

34. The apparatus of claim 27, further comprising means for synchronizing displaying of content items with an end of the data relating to the advertisement.
